(19) United States
(12) Patent Application Publication
(10) Pub. No.: US 2005/0019590 A1
(43) Pub. Date: Jan. 27, 2005

(54) Vibration damping material and vibration damper

(76) Inventor: Percy Josefsson, Ljungbyholm (SE)

Correspondence Address: BURNS DOANE SWECKER & MATHIS L L P, POST OFFICE BOX 1404, ALEXANDRIA, VA, 22313-1404, US

(21) Appl. No.: 10/489,207

(22) PCT Filed: Sep. 2, 2002
(86) PCT No.: PCT/SE02/01567

(30) Foreign Application Priority Data
Sep. 10, 2001 (SE) 0103002-2

(51) Int. Cl. B32B 15/06

(52) U.S. Cl. 428/457; 428/462

(57) ABSTRACT

A vibration damping material (10) comprising a laminate consisting of two (20,40) metal sheets with a rubber layer (30) sandwiched therebetween, and another rubber layer (50) attached to either of the metal sheets, the rubber layers being made of solid rubber foil or rubber film produced by carrier calendaring and vulcanised to the metal sheets. One of the metal sheet properties influenceable by sound, vibration, and/or temperature, is different between the metal sheets. A vibration damper for application to a panel, which vibration damper is made from the vibration damping material.

The present invention relates to a vibration damping material and vibration dampers made from this material. The vibration dampers according to the invention are particularly useful in the automotive industry, for application to various panels, such as panels of automobile bodies, e.g. engine parts.

A known method of damping vibration of a panel having a large surface area relative to the thickness is to apply a viscoelastic damping material in sheet form to the panel. In the viscoelastic material applied to the panel, a large amount of the mechanical or kinetic energy put into the material under vibration is converted into heat energy through molecular friction, and then dissipated.

Conventional vibration dampers for application to panels may be classified into the following categories:
Free or unconstrained layer damping This is the simplest way of introducing damping into a structure. This concept involves a simple layer of an appropriate damping material bonded to those surfaces of the structure which are vibrating. The damping involves cyclic tension/compression deformation, resulting in dissipation of energy.
Constrained layer damping. Variations of this concept are among the most efficient ways of introducing damping into a structure. Single constrained layer is the most familiar form of these treatments. It consists of a thin layer of damping material combined with a constraining layer of metallic foil or similar rigid material. The damping mechanism involves cyclic shear deformation of the damping material.

EP 0077987 discloses a constrained layer vibration damper in the form of a three-layered laminate, which comprises a meltable bonding layer to be brought into contact with a panel to be damped, a viscoelastic layer and a constraining layer laminated such that the viscoelastic layer is intimately sandwiched between the bonding layer and the constraining layer. The constraining layer of this damper is formed of a resin composition comprising an uncured thermosetting resin and an inorganic filler. The viscoelastic layer is formed of a viscoelastic and adhesive material, and serves the function of damping or attenuating mechanical vibrations and, besides, serves as an adhesive layer to bond the constraining layer to the meltable bonding layer. The viscoelastic layer can be provided by using a double-faced adhesive tape produced by coating both sides of a thin plastic film with a viscoelastic adhesive. Regarding the constraining layer, metals are explicitly excluded, as it is said in EP 0077987 that a metal constraining layer would make it difficult to bring the damper into dose contact with an intricately shaped panel.

U.S. Pat. No. 5,407,034 (Vydra) discloses a prior art damping structure including damping layers of viscoelastic material alternating with an outer metal layer, a middle metal layer and an inner metal layer. The layers are said to be bonded together in a suitable manner. A disadvantage of the disclosed prior art is said to be that the damping layer is subjected to significant torsional and rotational forces which can degrade it and impair noise-damping effectiveness. Furthermore, the prior art provides insufficient noise damping at lower frequencies. Vydra's solution to this problem is a brake pad assembly comprising a brake shoe structure including a rigid backing structure and a friction lining pad carried by it. The backing structure has a plurality of perforations and includes a rigid imperforate backing plate. A damping plate with perforations is fixed to the backing plate, and metal constraining layers are disposed along the opposite sides of the damping plate. Viscoelastic damping material is disposed in the perforations. The disclosed prior art, as well as Vydra's invention, comprise rigid plates, which is necessary in order to make the damping structure endure the forces applied by the brake piston. This means that the structure is not fit to be plastically shaped.

It has now been found that improved damping can be obtained by means of a vibration damping material as defined in appended claim 1. More particularly, the present vibration damping material comprises a laminate consisting of a first and a second thin metal sheet and a first rubber layer sandwiched therebetween, wherein said first rubber layer is a solid rubber foil or rubber film produced by carrier calendaring and vulcanised together with each of said metal sheets, and a second rubber layer, which is a solid rubber foil or rubber film produced by carrier calendaring, that is vulcanised together with said first or second metal sheet.

Preferably, said first rubber layer is thinner than about 0.5 mm, and in particular, it may have a thickness of about 0.1-0.08 mm.

The second rubber layer is preferably made as thin as possible. In a preferred case, it has a thickness of about 0.5 mm or less.

Said first metal sheet preferably has a thickness of about 0.3-1.5 mm.

Said second metal sheet preferably has a thickness of about 0.3-1.5 mm.

The metal sheets may be made of any suitable metal, although they are preferably made of carbon steel or aluminium.

The total bending stiffness of the laminate should preferably correspond to between about ⅓ to about 1/1 of the bending stiffness of the panel to be dampened.

In a preferred case, one or more of the metal sheet properties influenceable by sound, vibration, and/or temperature, is/are different between the first and the second metal sheet.

The rubber layers may be made of any suitable elastomer, although they are preferably made of nitrile or butyl rubber.

The rubber layers may be made electrically conductive, for instance by adding carbon black in effective quantities to the mixture prior to the calendaring process, as is known in the art. The use of electrically conductive rubber layers enables the material to be welded, e.g. spot-welded, for simple and effective adaptation, including jointing.

The rubber layer of the inventive laminated material has the smallest possible porosity. Thus, the rubber layer has those specific properties and the unique structure exhibited by carrier calendared rubber films. Among other things, there is obtained a homogeneity and evenness with regard to both physical properties and dimensions. For instance, the rubber layer shall be as free from pores to the greatest possible extent, a property which cannot be achieved with a rubber layer that has been applied in the form of a solution or paste and which has been rolled or pressed directly onto or between the metal sheets. Such rubber layers will always contain paste-forming residues or solvent residues that generate pore formations and other inhomogenities and thereby give rise to weakening zones, which also occur in any glue layers present. The rubber films should be applied to the metal sheet with the aid of a carrier used in the calendaring process, this carrier ensuring highly effective and primarily flat abutment with the surface of the metal sheet in the absence of tendencies to forming irregularities in the abutment surfaces. These conditions also enable vulcanisation of the rubber layer to the metal sheet to be effected readily with regard to the strength of the rubber-metal sheet bond.

Although the present vibration damping material may be attached to the panel to be dampened by way of gluing in situ, i.e. by supplying a separate adhesive at the time of applying the material to the panel, the present vibration damping material preferably comprises a layer of adhesive, applied to the surface of the second rubber layer facing away from the said first and second metal sheets.

The vibration damping material may be manufactured in accordance with the method described in WO 91/13758, which method involves the use of a disposable carrier in the production of rubber foil or rubber film by calendaring and subsequent vulcanisation in a belt vulcanising machine. When the rubber layer is produced in accordance with this method, the rubber foil or film thus formed obtains an homogeneity and evenness with regard to both its physical properties and its dimensions as indicated in the foregoing, for instance a very low porosity. Because the rubber layer is applied to the first metal sheet with the aid of a carrier, very effective and primarily flat abutment is ensured with the metal sheet surface with no tendencies towards irregularities in the abutting surfaces. The rubber coated first sheet can then be readily applied to the second metal sheet, because the first metal sheet functions as a stable carrier in this stage of manufacture. With these conditions, the rubber foil or rubber film can be vulcanised readily to both plates without problems concerning the mechanical strength of the rubber-metal sheet joints. The method of belt vulcanising in two stages is described in WO 93/13329.

The inventive material can, in principle, be handled and treated as though it were a metal plate and is plastically shaped and worked at least in a cold state by curving, bending, drawing, stretching, or pressing the material or subjecting said material to similar treatment, without the material loosing its vibration damping properties. This is because the material behaves as a homogenous product in this context, despite being a laminate. The reasons for this are because the rubber layer is solid and homogeneously produced by carrier calendaring, and because the layer is vulcanised directly onto the metal sheets in the absence of any binder layer which would otherwise create weak zones when shaping or working the material. The material thus exhibits no cracks or inhomogenities in the joint between the rubber-metal boundary surfaces, not even when the material is deformed when being worked. This is the reason why the material was found to exhibit good properties in tests carried out on the material. Vulcanisation of a solid rubber film to the metal sheets results in an homogenous structure and a firm bond across the whole surface of contact between the rubber layer and the metal sheet, and therewith in uniform damping properties.

The present invention also relates to a vibration damper for application to a panel to damp vibrations of the panel, which vibration damper is made from the present vibration damping material.

The present invention is useful for damping various automotive parts such as, for instance, oil pans, engine housings, cam housings, chain drive housings, and in particular housings made of aluminium.

The above and other objects, features and advantages of the present invention will become more readily apparent from the following description, reference being made to the accompanying drawing in which:

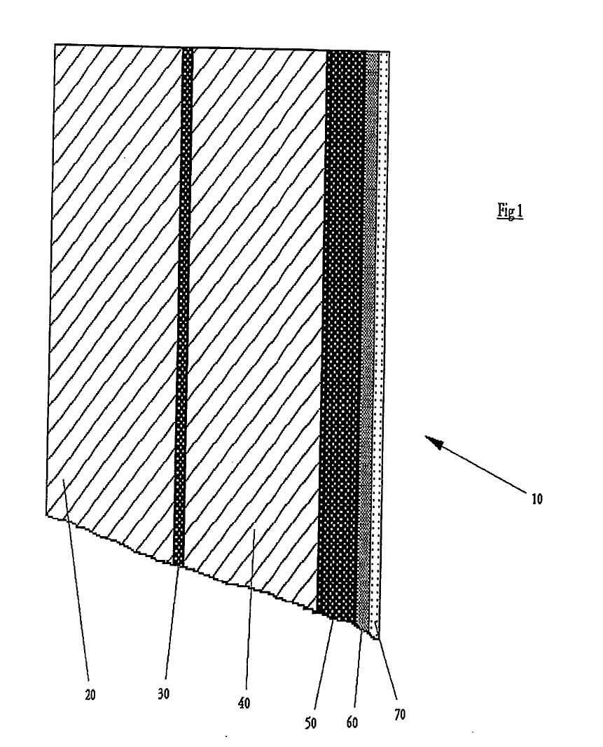

FIG. 1 is a diagrammatic cross section through a vibration damper laminate material according to one embodiment of the present invention;

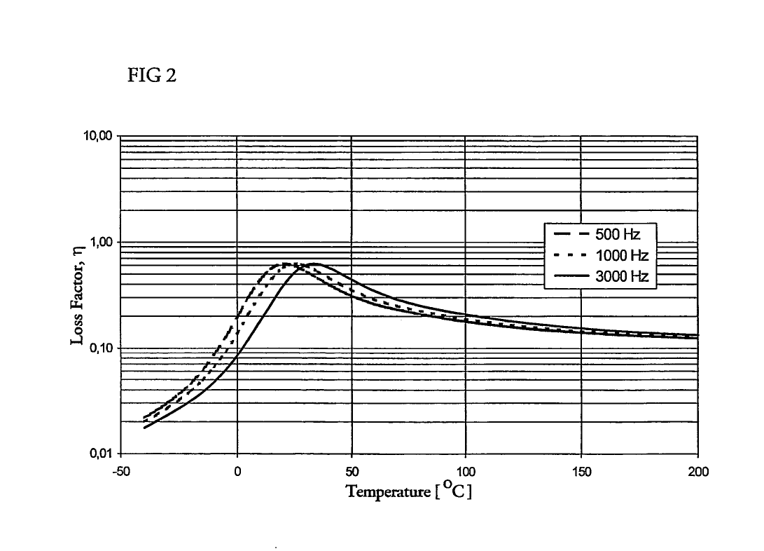

FIG. 2 is a graph showing Loss Factor variation with temperature, at various frequencies, for one embodiment of the invention; and

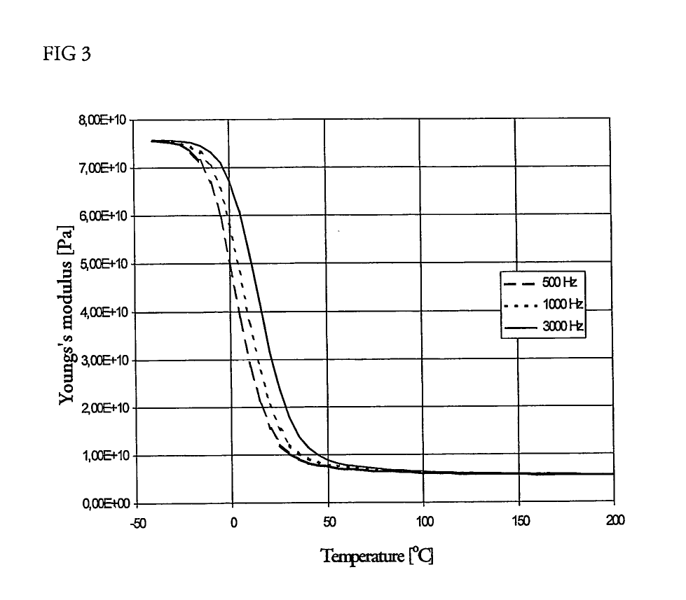

FIG. 3. is a graph showing Young's modulus variation with temperature, at various frequencies, for one embodiment of the invention.

In FIG. 1, in which the dimensions of the various layers have not been shown to scale, it will be apparent that the laminate material 10 can comprise a pair of metal plates 20 and 40 acting as constraining layers, between which a web 30 acting as a constrained layer, previously formed of rubber is sandwiched so that these sheets coat the elastomer core. A second web 50 also acting as a constrained layer, of rubber is bonded to the opposite side of metal plate 40. A layer 60 of pressure adhesive is applied on top of rubber web 50. The purpose of this pressure adhesive layer 60 is to bond dampers made of the vibration damper laminate material to various panels, such as the panels of automobile bodies, e.g. engine parts, the vibrations of which are to be damped. Before being applied and bonded accordingly, the pressure adhesive layer 60 is protected by a plastic protection 70.

### EXAMPLE

A vibration damper laminate was made from a metal-rubber-metal-rubber laminate constructed in accordance with the invention. The laminate comprised of 1.0 mm galvanised carbon steel—0.1 mm nitrile rubber—1.0 mm galvanised carbon steel—0.3 mm nitrile rubber. Loss factor for the laminate was measured according to the international standard ASTM E-756 98, which is a mechanical impedance procedure. The material was cut in 12.7 mm wide and 255 mm long samples, which were bonded to a bare steel basebeam. The beam was placed in a fixture including a non-touch exciter, which induces vibrations at the end of the cantilever beam. The basebeam was 2.93 mm thick, 12.7 mm wide and had a free length of 255 mm when placed in the fixture. The test was performed in an environmental chamber with a temperature range of −35° C. to 180° C., at frequencies of 500, 1000, and 3000 Hz. The measurement results are set forth in FIG. 1, which shows the material loss factor values as function of temperature after reduction of the basebeam, and FIG. 2, which shows the Young's modulus for the same beam as function of temperature.

1. A vibration damping material (10) comprising a laminate consisting of a first (20) and a second (40) metal sheet with a first rubber layer (30) sandwiched therebetween, and a second rubber layer (50) attached to either of said first or second metal sheets, characterised in that the rubber layers are solid rubber foil or rubber film produced by carrier calendaring and are vulcanised together with the respective metal sheet, and in that one or more of the metal sheet properties influenceable by sound, vibration, and/or temperature, is/are different between the first and the second metal sheet.

2. A vibration damping material according to claim 1, characterised in that it comprises a layer (60) of adhesive applied to the surface of the second rubber layer that faces away from the said first and second metal sheets.

3. A vibration damper for application to a panel to damp vibrations of the panel, characterised in that said vibration damper is made from a vibration damping material comprising a laminate consisting of a first and a second metal sheet with a first rubber layer sandwiched therebetween, and a second rubber layer attached to either of said first or second metal sheets, wherein the rubber layers are solid rubber foil or rubber film produced by carrier calendaring and are vulcanised together with the respective metal sheet, and in that one or more of the metal sheet properties influenceable by sound, vibration, and/or temperature, is/are different between the first and the second metal sheet.

4. A vibration damper according to claim 3(4), characterised in that it comprises a layer of adhesive applied to the surface of the second rubber layer, which layer of adhesive faces away from the said first and second metal sheets.

5. A vibration damper according to claim 3(4), characterised in that the total bending stiffness of the laminate corresponds to between about ⅓ to about 1/1 of the bending stiffness of the panel to be dampened.
